(19) United States
(12) Patent Application Publication
(10) Pub. No.: US 2010/0242716 A1
(43) Pub. Date: Sep. 30, 2010

(54) VACUUM BOOSTER DEVICE

(75) Inventor: Masahiro AWAJI, Plymouth, MI (US)

Correspondence Address: BUCHANAN, INGERSOLL & ROONEY PC, POST OFFICE BOX 1404, ALEXANDRIA, VA, 22313-1404, US

(73) Assignee: ADVICS CO., LTD., Kariya-city (JP)

(21) Appl. No.: 12/732,387

(22) Filed: Mar. 26, 2010

(30) Foreign Application Priority Data
Mar. 31, 2009 (JP) 2009-085083

(51) Int. Cl. B60T 13/52

(52) U.S. Cl. 91/376 R

(57) ABSTRACT

A vacuum booster device includes a housing, a movable partition mounted within the housing, a valve piston mounted at the housing in a movable manner, an input member, an output member, a reaction force member, a control valve including an air control valve portion and a negative pressure control valve portion, a key member specifying a limit of a movement of the input member relative to the valve piston in a front and rear direction, and a straightening portion arranged in an air passage that is formed between the input member and the valve piston and that is positioned at a front of the air valve portion and the air control valve portion, the straightening portion being formed into a shape to be prevented from projecting relative to an outer diameter portion of the air valve portion and arranged forward relative to the air valve portion by a predetermined distance.

### CROSS REFERENCE TO RELATED APPLICATIONS

This application is based on and claims priority under 35 U.S.C. §119 to Japanese Patent Application 2009-085083, filed on Mar. 31, 2009, the entire content of which is incorporated herein by reference.

### TECHNICAL FIELD

This disclosure relates to a vacuum booster device used for a brake apparatus for a vehicle.

### BACKGROUND DISCUSSION

A known vacuum booster device includes, for example, a housing forming therein a pressure chamber, a movable partition mounted within the housing in a movable manner in a front and rear direction and dividing the pressure chamber into a negative pressure chamber at a front and a variable pressure chamber at a rear, and a valve piston mounted at the housing in a movable manner in the front and rear direction and including a front end portion which is accommodated within the housing and by means of which the valve piston is connected to the movable partition. The vacuum booster device also includes an input member mounted to be movable relative to the valve piston in the front and rear direction within the valve piston and receiving an operation force from an outside, an output member mounted at the front end portion of the valve piston and outputting a driving force of the valve piston to the outside, and a reaction force member disposed between the input member and the output member within the valve piston and transmitting a reaction force against a force applied to the output member to the valve piston and the input member in a dividing manner. The vacuum booster device further includes a control valve mounted within the valve piston and having an air control valve portion selectively permitting and prohibiting, together with an annular air valve portion provided at the input member, a communication between the variable pressure chamber and air and a negative pressure control valve portion selectively permitting and prohibiting, together with a negative pressure valve seat provided at the valve piston, a communication between the variable pressure chamber and the negative pressure chamber, a key member mounted to be movable relative to the input member and the valve piston in the front and rear direction and specifying a limit of a movement of the input member relative to the valve piston in the front and rear direction, and a straightening portion arranged in an air passage that is formed between the input member and the valve piston and that is positioned at a front of the air valve portion and the air control valve portion, the air passage introducing an air flowing therein from a portion between the air valve portion and the air control valve portion to the variable pressure chamber, the straightening portion being formed into a shape to be prevented from projecting relative to an outer diameter portion of the air valve portion and arranged forward relative to the air valve portion by a predetermined distance. Such vacuum booster device is disclosed in JP3635677B (hereinafter referred to as Reference 1). In this case, the “rear” mentioned above corresponds to a direction close to a brake pedal or a rear side of a vehicle relative to the vacuum booster device. In addition, the “front” mentioned above corresponds to a direction close to a brake master cylinder or a front side of the vehicle relative to the vacuum booster device.

According to the vacuum booster device disclosed in Reference 1, the air control valve portion and the negative pressure control valve portion of the control valve are separated by a predetermined distance in an axial direction of the valve piston to thereby define a cylindrical portion connecting the air control valve portion and the negative pressure control valve portion. Then, a cylindrical-shaped sound deadening member is provided at the cylindrical portion. A suction noise generated when air flowing through a portion between the air valve portion and the air control valve portion is led to the variable pressure chamber (resulting from a generation of a vortex, at the front of the air valve portion) is reduced by the sound deadening member.

However, the sound deadening member disclosed in Reference 1 formed into the cylindrical shape allows an air penetration. An inner diameter of the sound deadening member is larger than an outer diameter of the air valve portion. Thus, substantially the full volume of air passing through the portion between the air valve portion and the air control valve portion penetrates through the sound deadening member. As a result, the air flowing to the variable pressure chamber may be interrupted (i.e., a flow passage resistance at an air passage where air is led to the variable pressure chamber increases by the sound deadening member), thereby deteriorating an operation responsiveness of the vacuum booster device.

A need thus exists for a vacuum booster device which is not susceptible to the drawback mentioned above.

### SUMMARY

According to an aspect of this disclosure, a vacuum booster device includes a housing forming therein a pressure chamber, a movable partition mounted within the housing in a movable manner in a front and rear direction and dividing the pressure chamber into a negative pressure chamber at a front and a variable pressure chamber at a rear, a valve piston mounted at the housing in a movable manner in the front and rear direction and including a front end portion which is accommodated within the housing and by means of which the valve piston is connected to the movable partition, an input member mounted to be movable relative to the valve piston in the front and rear direction within the valve piston and receiving an operation force from an outside, an output member mounted at the front end portion of the valve piston and outputting a driving force of the valve piston to the outside, a reaction force member disposed between the input member and the output member within the valve piston and transmitting a reaction force against a force applied to the output member to the valve piston and the input member in a dividing manner, a control valve mounted within the valve piston and including an air control valve portion selectively permitting and prohibiting, together with an annular air valve portion provided at the input member, a communication between the variable pressure chamber and air and a negative pressure control valve portion selectively permitting and prohibiting, together with a negative pressure valve seat provided at the valve piston, a communication between the variable pressure chamber and the negative pressure chamber, a key member mounted to be movable relative to the input member and the valve piston in the front and rear direction and specifying a limit of a movement of the input member relative to the valve piston in the front and rear direction, and a straightening portion arranged in an air passage that is formed between the input member and the valve piston and that is positioned at a front of the air valve portion and the air control valve portion, the air passage introducing an air flowing therein from a portion between the air valve portion and the air control valve portion to the variable pressure chamber, the straightening portion being formed into a shape to be prevented from projecting relative to an outer diameter portion of the air valve portion and arranged forward relative to the air valve portion by a predetermined distance.

### BRIEF DESCRIPTION OF THE DRAWINGS

The foregoing and additional features and characteristics of this disclosure will become more apparent from the following detailed description considered with the reference to the accompanying drawings, wherein;

FIG. 1 is a partially fragmented side view of a vacuum booster device according to an embodiment disclosed here;

FIG. 2 is an enlarged cross-sectional view of a main portion of the vacuum booster device;

FIG. 3 is an enlarged cross-sectional view of the main portion of the vacuum booster device according to another embodiment disclosed here;

FIG. 4 is a perspective view of a straightening portion shown in FIG. 3;

FIG. 5 is a modified example of the straightening portion;

FIG. 6 is a diagram illustrating a relationship between an operation responsiveness (i.e., an air flow volume passing through an air passage) obtained by the straightening portion of the vacuum booster device and an axial clearance between an atmosphere valve portion and the straightening portion according to the embodiments disclosed here; and

FIG. 7 is a diagram illustrating a relationship between quietness (i.e., a sound pressure energy at the air passage) and the axial clearance between the atmosphere valve portion and the straightening portion according to the embodiments disclosed here.

### DETAILED DESCRIPTION

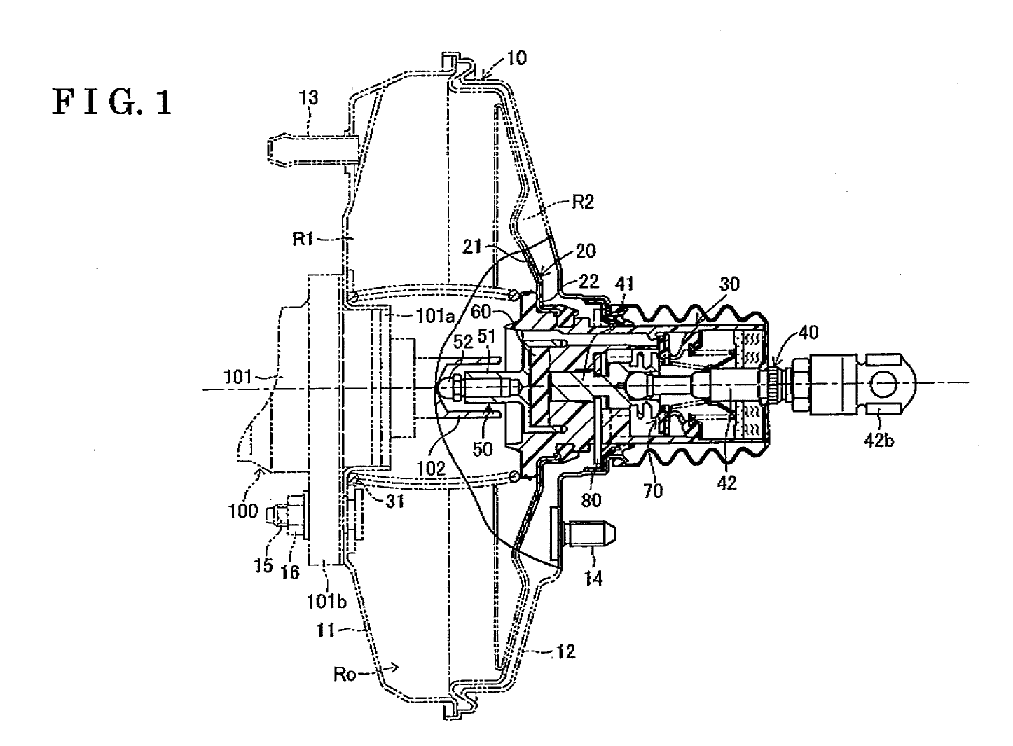

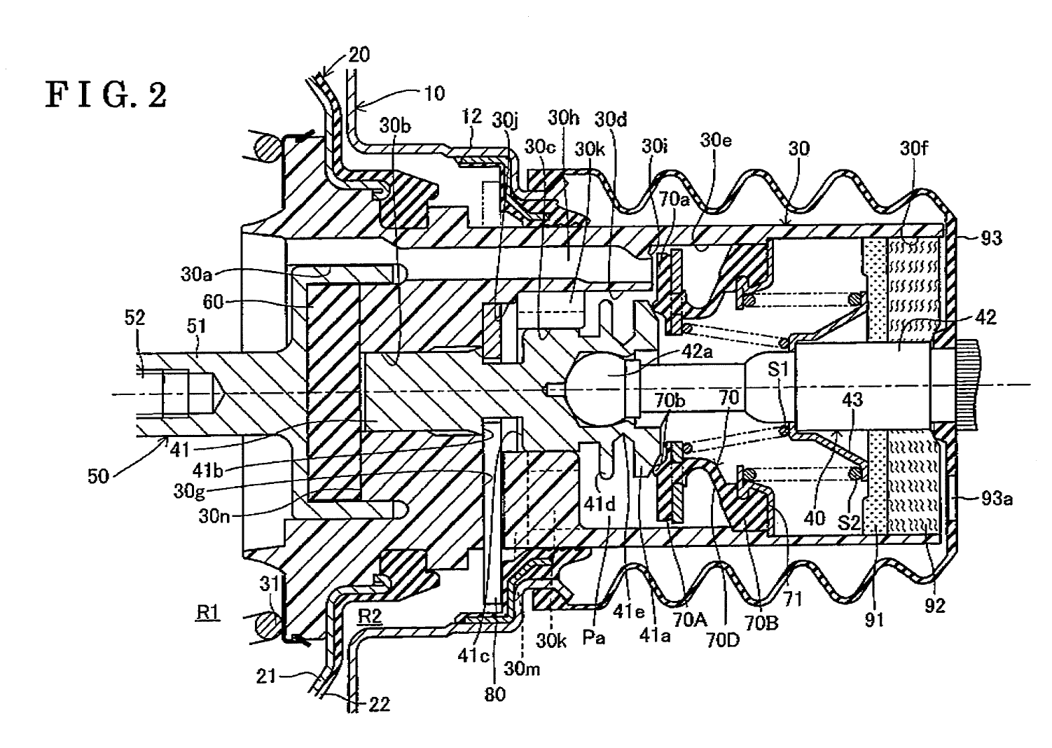

An embodiment of the disclosure will be explained with reference to the attached drawings. As illustrated in FIGS. 1 and 2, a vacuum booster device according to the present embodiment includes a housing 10, a movable partition 20 mounted at the housing 10, and a valve piston 30. The vacuum booster device further includes an input member 40, an output member 50, a reaction force member 60, a control valve 70, and a key member 80 all of which are assembled on the valve piston 30. In the following, a “front” corresponds to a direction close to an engine (i.e., a front side of a vehicle corresponding to a right side in FIGS. 1 to 3) and a “rear” corresponds to a direction close to a brake pedal (i.e., a rear side of a vehicle corresponding to a right side in FIGS. 1 to 3) relative to the vacuum booster device.

As illustrated in FIG. 1, the housing 10 includes a front shell 11 and a rear shell 12 by means of which a pressure chamber Ro is formed. The pressure chamber Ro formed within the housing 10 is divided into a negative pressure chamber R1 provided at a front side and a variable pressure chamber R2 provided at a rear side of the vacuum booster device by means of the movable partition 20. The negative pressure chamber R1 is constantly connected to a negative pressure source such as an intake manifold of an engine via a negative pressure inlet tube 13. The variable pressure chamber R2 is selectively connected to or disconnected from the negative pressure chamber R1 and air (i.e., an outer atmosphere). The housing 10 is configured to be fixed to a vehicle body by means of multiple bolts 14 (in FIG. 1, only one of the bolts 14 is illustrated) that air-tightly penetrates through the rear shell 12 and by means of nuts screwed with the respective bolts 14. In addition, a brake master cylinder 100 is mounted at a front portion of the housing 10 by means of multiple bolts 15 (in FIG. 1, only one of the bolts 15 is illustrated) that air-tightly penetrate through the front shell 11 and nuts 16 screwed with the respective bolts 15. In this case, the bolt 14 and the bolt 15 may be constituted by a single bolt that air-tightly penetrate through the movable partition 20 at an intermediate portion.

The movable partition 20, which includes a metal plate 21 and a rubber diaphragm 22, is mounted within the housing 10 so as to be movable in a front and rear direction. The diaphragm 22 is air-tightly sandwiched by the rear shell 12 and the front shell 11. Specifically, a bead portion formed at an outer circumferential edge of the diaphragm 22 is sandwiched by a folding portion formed at an outer circumferential edge of the rear shell 12 and the front shell 11. In addition, the diaphragm 22 together with the plate 21 are air-tightly fixed to a groove formed at an outer periphery of a front flange portion of the valve piston 30. Specifically, a bead portion formed at an inner circumferential edge of the diaphragm 22 is fixed to the groove formed at the outer periphery of the front flange portion of the valve piston 30.

The brake master cylinder 100 illustrated in FIG. 1 includes a cylinder body 101 and a piston 102. A rear end portion 101a of the cylinder body 101 penetrates through a center cylinder portion of the front shell 11 so as to air-tightly project into the negative pressure chamber R1. In addition, a rear surface of a flange portion 101b of the cylinder body 101 is in contact with a front surface of the front shell 11. The piston 102 of the brake master cylinder 100 projects rearward from the cylinder body 101 into the negative pressure chamber R1. The piston 102 is configured to be pressed forward by a front end portion of the output member 50.

The valve piston 30 is a hollow-shaped piston connected to the movable partition 20 at a front end that is accommodated within the housing 10. The valve piston 30 is air-tightly mounted at the rear shell 12 at a cylindrical portion so as to be movable in the front and rear direction. The valve piston 30 is biased rearward by a spring 31 disposed between the valve piston 30 and the front shell 11 of the housing 10. As illustrated in FIG. 2, a shaft center of the valve piston 30 includes, from a front end to a rear end, a reaction force chamber bore 30a, a plunger end portion accommodating bore 30b having a diameter smaller than that of the reaction force chamber bore 30a, a first plunger accommodating bore 30c, a second plunger accommodating bore 30d having a diameter larger than that of the first plunger accommodating bore 30c, a control valve accommodating bore 30e, and a filter accommodating bore 30f. As a result, the valve piston 30 includes a shaft bore penetrating in the front and rear direction.

The valve piston 30 also includes a key member insertion bore 30g in a radial direction so as to face the first plunger accommodating bore 30c. The valve piston 30 further includes a pair of connection bores 30h (in FIG. 2, only one of the connection bores 30h is illustrated) that connects the negative pressure chamber R1 to the control valve accommodating bore 30e. Arc-shaped negative pressure valve seats 30i are formed at respective rear end portions of the connection bores 30h. A negative pressure control valve portion 70a of the control valve 70 is selectively seated on the negative pressure valve seats 30i. The valve piston 30 further includes a key member accommodating bore 30j accommodating an axial center portion of the key member 80, multiple axial connection bores 30k connecting the key member accommodating bore 30j to the second plunger accommodating bore 30d, and a radial connection bore 30m connecting the key member accommodating bore 30j and the axial connection bore 30k to the variable pressure chamber R2.

The input member 40 is arranged within the valve piston 30 so as to be movable in the front and rear direction relative to the valve piston 30 and so as to receive an operation force (i.e., receiving an input) from the outside. The input member 40 includes a plunger 41 and an input rod 42. The plunger 41 is accommodated between the plunger end portion accommodating bore 30b and the control valve accommodating bore 30e of the valve piston 30 so as to be movable in an axial direction of the valve piston 30 (i.e., in the front and rear direction). The input rod 42 includes a spherical end portion 42a connected to the plunger 41 in a joint manner and a rear end portion 42b (see FIG. 1) connected to a brake pedal.

As illustrated in FIG. 2, the plunger 41 is supported and guided by the valve piston 30 while a front end portion of the plunger 41 is assembled on the plunger end portion accommodating bore 30b so as to be axially slidable and an intermediate portion of the plunger 41 is assembled on the first plunger accommodating bore 30c so as to be axially slidable. The plunger 41 is engageable (i.e., selectively makes contact), via a front end (front end surface), with the reaction force member 60 accommodated in the reaction force chamber bore 30a of the valve piston 30. An annular-shaped air valve seat (air valve portion) 41a that is selectively seated on an air control valve portion 70b of the control valve 70 is formed at a rear end of the plunger 41.

The output member 50 outputs a driving force of the valve piston 30 to the outside. The output member 50 includes a rear member 51 and an output rod 52 (see FIG. 1). The rear member 51, in addition to the reaction force member 60, is assembled on the reaction force chamber bore 30a of the valve piston 30 so as to be axially movable. The output rod 52 is integrally mounted at an end portion of the rear member 51. A front end of the output rod 52 is in contact with an engagement portion of the piston 102 of the brake master cylinder 100 in a pressing manner as illustrated in FIG. 1.

The reaction force member 60 is a reaction rubber disc disposed between the input member 40 and the output member 50 within the valve piston 30. A front end surface of the reaction force member 60 is in contact with a rear end surface of the rear member 51 of the output member 50 while a rear end surface of the reaction force member 60 is in contact with an annular reaction force receiving surface 30n of the valve piston 30 and is engageable with the front end surface of the plunger 41. A reaction force against a force applied to the output member 50 is divided and transmitted to the valve piston 30 and the input member 40 (i.e., the plunger 41).

The control valve 70 includes an annular movable portion 70A, an annular fixed portion 70B, and a cylindrical extending portion 700. The annular movable portion 70A includes the aforementioned negative pressure control valve portion 70a and the air control valve portion 70b. The annular fixed portion 70B is air-tightly fitted and fixed to a stepped portion formed at the control valve accommodating bore 30e of the valve piston 30. The cylindrical extending portion 70D connects the annular movable portion 70A and the annular fixed portion 70B to each other. The annular movable portion 70A is biased forward by a first spring 81 disposed between the annular movable portion 70A and a retainer 43 mounted at the input rod 42 and is movable in the front and rear direction. The annular fixed portion 70B is fixed to the valve piston 30 by means of an annular retainer 71 and is biased forward by a second spring S2 disposed between the annular fixed portion 70B and the retainer 43 mounted at the input rod 42.

The second spring 52 is a return spring disposed between the valve piston 30 and the input member 40 so as to bias the input member 40 rearward to a predetermined position relative to the valve piston 30. The second spring 82 engages with the valve piston 30 at a front end via the retainer 71 and engages with the input rod 42 of the input member 40 at a rear end via the retainer 43. The retainer 71 is assembled on the valve piston 30, specifically, fixed to an inner bore stepped portion of the valve piston 30 to thereby exercise a function to fix the annular fixed portion 70B of the control valve 70 to the valve piston 30. The retainer 43 is assembled on the input rod 42 so as to be fixed to an outer circumferential stepped portion of the input rod 42.

The negative pressure control valve portion 70a is selectively seated on and separated from the pair of arc-shaped negative pressure valve seats 30i formed at the valve piston 30. In a case where the negative pressure control valve portion 70a is seated on the pair of negative pressure valve seats 30i, the negative pressure chamber R1 and the variable pressure chamber R2 are disconnected from each other. In a case where the negative pressure control valve portion 70a is separated from the pair of negative pressure valve seats 30i, the negative pressure chamber R1 and the variable pressure chamber R2 are connected to each other. The air control valve portion (valve seat) 70b is selectively seated on and separated from the annular-shaped air valve portion 41a formed at the plunger 41. In a case where the air control valve portion 70b is seated on the annular air valve portion 41a, the variable pressure chamber R2 and air are disconnected to each other. In a case where the air control valve portion 70b is separated from the annular air valve portion 41a, the variable pressure chamber R2 and atmosphere are connected from each other.

The key member 80 restricts the axial movement (i.e., the movement in the front and rear direction) of the plunger 41 relative to the valve piston 30 and restricts the axially rearward movement (i.e., a rearward position) of the valve piston 30 relative to the housing 10. The key member 80 is mounted so as to be movable relative to the plunger 41 and the valve piston 30 in the front and rear direction. The key member 80 is inserted into the key member insertion bore 30g formed at the valve piston 30. A thickness of the key member 80 in the front and rear direction is smaller than a dimension of the key member insertion bore 30g in the front and rear direction. The key member 80 is movable in the front and rear direction relative to the valve piston 30 by a predetermined distance.

The key member 80 selectively makes contact with the rear shell 12 at rear end surfaces formed at both end portions of the key member 80 that radially extend. The rearward movement of the valve piston 30 relative to the housing 10 is restricted at a position, as illustrated in FIG. 2, where a front wall of the key member insertion bore 30g is in contact with a front end surface of the key member 80 and the rear end surfaces of the both end portions of the key member 80 are in contact with the rear shell 12.

The key member 80 selectively makes contact with both a front end surface 41b and a rear end surface 41c of an annular groove formed at a center portion of the plunger 41. The plunger 41 is first assembled on the valve piston 30 and then the key member 80 is assembled thereon. A rearward movement of the plunger 41 relative to the valve piston 30 is restricted at a position where the front end surface 41b of the annular groove is in contact with the front end surface of the key member 80 and the rear end surface of the key member 80 is in contact with a rear wall of the key member insertion bore 30g. In addition, a forward movement of the plunger 41 relative to the valve piston 30 is restricted at a position where the rear end surface 41c of the annular groove is in contact with the rear end surface of the key member 80 and the front end surface of the key member 80 is in contact with the front wall of the key member insertion bore 30g.

Filters 91 and 92 are disposed within the filter accommodating bore 30f of the valve piston 30 so as to surround the input rod 42. Air flows to the filters 91 and 92 by penetrating through a vent hole 93a formed at a cover portion 93 that protects a sliding portion of the valve piston 30 by covering an outer periphery thereof. The boot portion 93 is fitted and fixed, via a front end, to a rear end cylindrical portion of the rear shell 12 of the housing 10. The boot portion 93 is fitted and fixed, via a rear end, to an outer periphery of a center portion of the input rod 42.

According to the vacuum booster device having the aforementioned structure, the variable pressure chamber R2 is disconnected from the negative pressure chamber R1 and connected to air in association with the forward movement of the input member 40 relative to the valve piston 30 at a time of a brake operation. Then, because of air flowing to the variable pressure chamber R2, the valve piston 30 moves forward. At this time, the reaction force from the reaction force member 60 is transmitted to the valve piston 30 and the plunger 41 of the input member 40. At a time of release of the aforementioned brake operation, the variable pressure chamber R2 is disconnected from air and connected to the negative pressure chamber R1 in association with the rearward movement of the input member 40 relative to the valve piston 30. Then, the variable pressure chamber R2 turns to the negative pressure so that the valve piston 30 moves rearward by the spring 31. Accordingly, each component returns to an original position shown in FIG. 2 to be ready for the next brake operation.

According to the vacuum booster device of the present embodiment, an annular straightening portion 41d is formed at the plunger 41 so as to be positioned at a front of the air valve portion 41a and the air control valve portion 70b. Specifically, the annular straightening portion 41d is integrally formed with the air valve portion 41a at the plunger 41 in such a manner to be positioned forward relative to the air valve portion 41a by a predetermined distance. A rivet formed portion 410 is defined between the annular straightening portion 41d and the air valve portion 41a where the plunger 41 is connected to the spherical end portion 42a of the input rod 42. In addition, the annular straightening portion 41d is formed in such a manner not to radially project from an outer diameter portion of the air valve portion 41a. The annular straightening portion 41d is arranged in an air passage Pa formed between the second plunger accommodating bore 30d and an outer periphery of the plunger 41. The air passage Pa is connected to the variable pressure chamber R2 via the axial connection bore 30k and the radial connection bore 30m of the valve piston 30 to thereby introduce air flowing between the air valve portion 41a and the air control valve portion 70b to the variable pressure chamber R2.

Therefore, according to the vacuum booster device of the present embodiment, the straightening portion 41d arranged at the front by the predetermined distance relative to the air valve portion 41a restrains a vortex that may be generated at the front of the air valve portion 41a at a time when air passes through the air passage Pa. Consequently, a malfunction caused by such vortex (i.e., a generation of a suction noise in the air passage Pa) may be restrained. In addition, because the straightening portion 41d provided in the air passage Pa is prevented from radially projecting from the outer diameter portion of the air valve portion 41a, an increase of flow passage resistance in the air passage Pa is restrained, thereby desirably maintaining the operation responsiveness of the vacuum booster device.

In addition, according to the vacuum booster device of the present embodiment, the straightening portion 41d is formed into the annular shape and is integrally formed with the air valve portion 41a in such a manner to be positioned forward relative thereto. Thus, a space formed in front of the air valve portion 41a where the vortex is possibly generated is split by the annular-shaped straightening portion 41d, thereby effectively restraining the vortex from being generated. Further, according to the present embodiment, increases of components and an assembly process are prevented while a productivity is maintained to achieve a cost reduction.

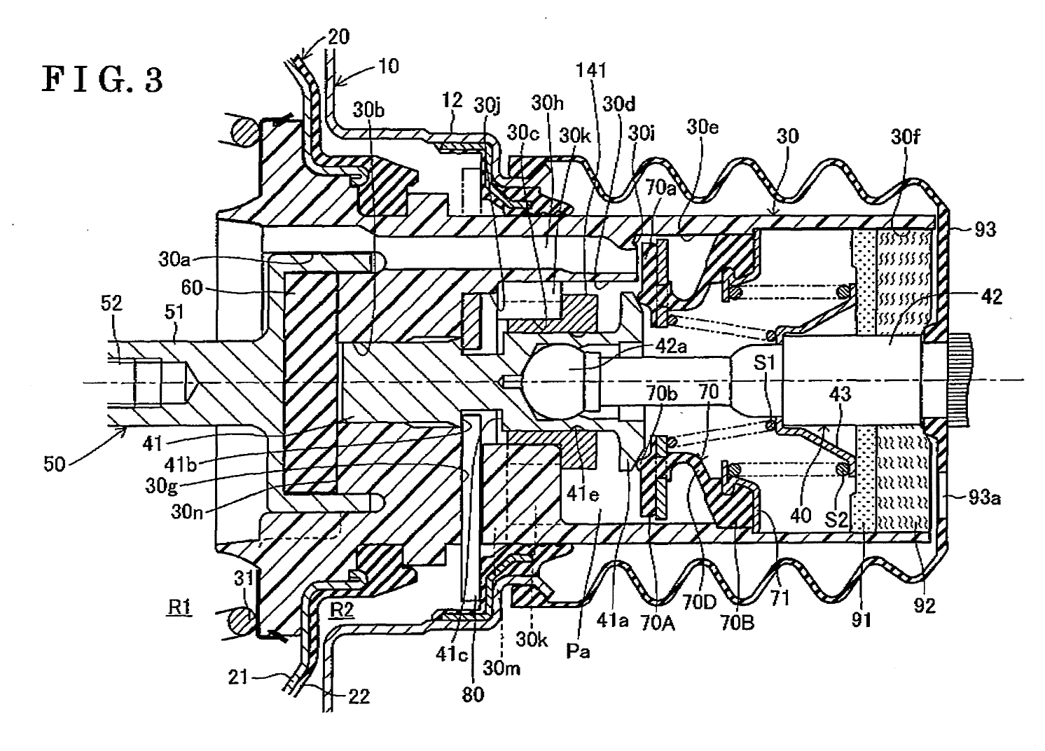

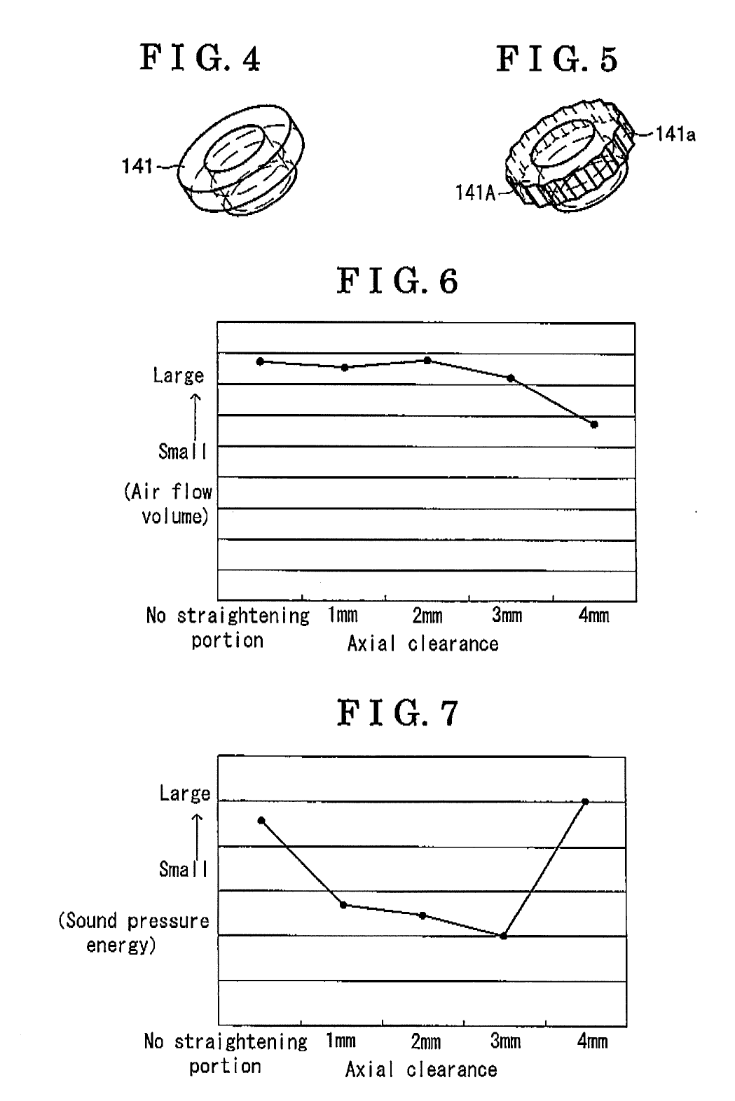

According to the aforementioned embodiment, the straightening portion 41d is integrally formed with the air valve portion 41a. Alternatively, as illustrated in FIGS. 3 and 4 according to another embodiment, a straightening member (straightening portion) 141 that functions in the same way as the straightening portion 41d may be formed into a stepped cylindrical shape separately from the input member 40 and the valve piston 30. The straightening member 141 is then integrally assembled on the valve piston 30 at the front of the air valve portion 41a by a predetermined distance. In this case, a space formed in front of the air valve portion 41a where the vortex is possibly generated (i.e., where air possibly flows around) is reduced by the straightening member 141 having the stepped cylindrical shape, thereby restraining the vortex generation.

Further, in the aforementioned case, an axial clearance formed between the air valve portion 41a and the straightening member 141 is variable depending on an operation speed (i.e., a depression speed) of the input member 40. When the operation speed is greater than a first reference value, the aforementioned axial clearance is smaller than a second reference value to thereby effectively obtain a desired operation responsiveness of the vacuum booster device. When the operation speed is smaller than the first reference value, the aforementioned axial clearance is greater than the second reference value to thereby effectively obtain a desired quietness. Such effects are easily estimated by FIG. 6 illustrating a relationship between an air flow volume flowing through the air passage Pa and the axial clearance between the air valve portion 41a and the straightening member 141 and by FIG. 7 illustrating a relationship between a sound pressure energy and the axial clearance between the air valve portion 41a and the straightening member 141. Diagrams in FIGS. 6 and 7 have been obtained experimentally and analytically. Because the straightening member 141 is separately provided from the input member 40 and the valve piston 30, multiple straightening members having different shapes (for example, different axial lengths) are prepared beforehand and the desirable straightening member is selected to thereby appropriately control the effects obtained by the straightening member.

According to another embodiment illustrated in FIGS. 3 and 4, instead of the straightening member 141, a straightening member (straightening portion) 141A as illustrated in FIG. 5 may be applicable. The straightening member 141A illustrated in FIG. 5 includes multiple grooves 141a, axially extending, at an outer periphery. Thus, a straightening effect may be enhanced by the multiple grooves 141a, which leads to an improvement of suppression of the vortex generation by the straightening member 141A.

According to another embodiment illustrated in FIGS. 3 and 4, the straightening member (straightening portion) 141 is separately formed from the input member 40 and the valve piston 30 into the stepped cylindrical shape. Alternatively, an annular-shaped straightening member (portion) corresponding to the straightening member 141 may be integrally formed at the valve piston 30. In such case, the same effects as those for another embodiment illustrated in FIGS. 3 and 4 may be obtained.

According to the aforementioned embodiments, a single-type vacuum booster device is applied. Alternatively, a tandem or triple vacuum booster device may be applied. Further, modifications and changes may be conducted within the scope of the embodiments.

According to the aforementioned embodiments, the straightening portion 41d is formed into an annular shape and integrally formed with the air valve portion 41a at a position forward relative to the air valve portion 41a by the predetermined distance.

In addition, the straightening portion 141 is formed into an annular shape and integrally formed with the valve piston 30 at a position forward relative to the air valve portion 41a by the predetermined distance.

Further, the straightening portion 141 is formed into a cylindrical shape separately from the input member 40 and the valve piston 30 and is integrally mounted at the valve piston 30 at a position forward relative to the air valve portion 41a by the predetermined distance.

Furthermore, the straightening portion 141A includes a plurality of grooves 141a at an outer periphery, the plurality of grooves 141a extending in an axial direction of the straightening portion 141A.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vacuum booster device comprising:
a housing forming therein a pressure chamber;
a movable partition mounted within the housing in a movable manner in a front and rear direction and dividing the pressure chamber into a negative pressure chamber at a front and a variable pressure chamber at a rear;
a valve piston mounted at the housing in a movable manner in the front and rear direction and including a front end portion which is accommodated within the housing and by means of which the valve piston is connected to the movable partition;
an input member mounted to be movable relative to the valve piston in the front and rear direction within the valve piston and receiving an operation force from an outside;
an output member mounted at the front end portion of the valve piston and outputting a driving force of the valve piston to the outside;
a reaction force member disposed between the input member and the output member within the valve piston and transmitting a reaction force against a force applied to the output member to the valve piston and the input member in a dividing manner;
a control valve mounted within the valve piston and including an air control valve portion selectively permitting and prohibiting, together with an annular air valve portion provided at the input member, a communication between the variable pressure chamber and air and a negative pressure control valve portion selectively permitting and prohibiting, together with a negative pressure valve seat provided at the valve piston, a communication between the variable pressure chamber and the negative pressure chamber;
a key member mounted to be movable relative to the input member and the valve piston in the front and rear direction and specifying a limit of a movement of the input member relative to the valve piston in the front and rear direction; and
a straightening portion arranged in an air passage that is formed between the input member and the valve piston and that is positioned at a front of the air valve portion and the air control valve portion, the air passage introducing an air flowing therein from a portion between the air valve portion and the air control valve portion to the variable pressure chamber, the straightening portion being formed into a shape to be prevented from projecting relative to an outer diameter portion of the air valve portion and arranged forward relative to the air valve portion by a predetermined distance.

2. The vacuum booster device according to claim 1, wherein the straightening portion is formed into an annular shape and integrally formed with the air valve portion at a position forward relative to the air valve portion by the predetermined distance.

3. The vacuum booster device according to claim 1, wherein the straightening portion is formed into an annular shape and integrally formed with the valve piston at a position forward relative to the air valve portion by the predetermined distance.

4. The vacuum booster device according to claim 1, wherein the straightening portion is formed into a cylindrical shape separately from the input member and the valve piston and is integrally mounted at the valve piston at a position forward relative to the air valve portion by the predetermined distance.

5. The vacuum booster device according to claim 4, wherein the straightening portion includes a plurality of grooves at an outer periphery, the plurality of grooves extending in an axial direction of the straightening portion.
